(19) United States
(12) Patent Application Publication
(10) Pub. No.: US 2026/0366644 A1
(43) Pub. Date: Nov. 19, 2026

(54) Device for Automating Manually Operated Valves

(71) Applicant: Batfer Investment S.A., Montevideo (UY)

(72) Inventors: Sebastian Tome, Buenos Aires (AR); Tomas Ignacio Massun, Buenos Aires (AR)

(21) Appl. No.: 19/332,670

(22) Filed: Sep. 18, 2025

(30) Foreign Application Priority Data
May 17, 2025 (AR) P20250101341

(51) Int. Cl. F16K 37/00; F16K 31/60

(52) U.S. Cl. CPC F16K 37/0041; F16K 31/60; F16K 37/0008

(57) ABSTRACT

The invention provides an adjustable device for the automation of manually operated valves (A), comprising a valve body (a) with a fluid inlet (b) and a fluid outlet (c), wherein the fluid inlet and outlet include connection means (d); an actuating stem (e) connected at one end to an element for opening and closing the valve, and at its opposite end to a manual actuating handwheel (f) of the valve (A); wherein the adjustable device for the automation of manually operated valves includes an adjustable support (1) configured to be connected to the connection means (d) of the manually operated valve (A), a drive motor (2) mounted on the adjustable support (1), a rotating shaft (7) configured to be operatively connected at one end to the drive motor (2) through the power output shaft thereof and at its opposite end to the valve handwheel (f), a position sensor (9) disposed on the adjustable support (1) for detecting the position of the valve (A), a remote control and monitoring unit (12) in communication with the at least one position sensor (9) wherein the remote control and monitoring unit (12) is configured to actuate the manual valve (A) by means of the drive motor (2).

### CROSS REFERENCE TO RELATED APPLICATION

This application claims priority to Argentine Application No. P20250101341 filed on May 17, 2025, the disclosure of which is incorporated herein by reference for all purposes.

### TECHNICAL FIELD OF INVENTION

The present invention relates to an adjustable device for the automation of manually operated valves, configured to adapt to any existing manual valve design.

Specifically, the invention relates to the automation of existing gate-type valves installed in oil/gas/water fracturing or production equipment, or any valve present in an industrial facility.

### BACKGROUND OF THE INVENTION

Numerous devices for the automated actuation of manual valves are known in the prior art, such as that featured in utility model CN221075270 (U), which discloses a control valve with a temperature-sensing device, comprising a control valve body with an inner cavity of the control valve body that is fixedly connected to a temperature sensor, where the inner cavity of the control valve body is provided with a valve plate. A first rotating rod is fixedly connected to the top of the valve plate; a rotating handwheel is fixedly connected to the top of said first rotating rod; a frame is fixedly attached to the top of the control valve body; a motor is fixedly mounted on top of said frame, and a second rotating rod is fixedly connected to the output shaft end of the motor. In this document, the frame that attaches to the valve body and supports a drive motor is fixed, meaning its dimensions are not adjustable, and therefore, it is not configured to fit any valve design.

Another example of similar solutions is shown in utility model CN208074241U, which discloses a gate valve driven by a motor that closes the valve quickly enough using mechanical rotational energy and opens the valve to drive the handwheel, which can greatly improve work efficiency. The servomotor mechanically rotates the valve handwheel, allowing the valve to close and open quickly, greatly improving work efficiency.

However, this device is not configured to fit any valve design.

Therefore, in the prior art, there is still a need for novel and more versatile devices for the automation of manually operated valves that are more efficient, less expensive to manufacture, can be adapted to any type of valves existing on the market and can be installed quickly and simply on any valve, particularly on an existing valve in a hydrocarbon, gas or water fracturing or production facility or in any industrial facility that includes manually operated valves and where their automation is required without the need to uninstall the valve for the connection thereof.

### BRIEF SUMMARY OF THE INVENTION

The invention provides a device for the automation of manually operated valves that can be installed on any valve regardless of its design, size, pressure rating (RWP), performance requirements (PR), material type, among other aspects, solving the problems of the prior art and others as will become evident from the description of the invention.

The adjustable device for the automation of manually operated valves of the present invention can be installed on any type of valve, particularly valves already installed in surface well equipment for fracturing operations or hydrocarbon/gas/water production, or in industrial valves. This entails significant advantages from an operational and safety perspective, as it does not require uninstalling the valve for connection, resulting in reduced downtime, lower costs, and reduced risks for personnel, given that their time spent in the high-pressure zone is significantly reduced, while it also allows for automated and remote control of the automated manually operated valve(s).

The device for automating a manually operated valve according to the present invention is connected to an external power source, which may be hydraulic, pneumatic, or electric in nature.

Additionally, the adjustable device for the automation of manually operated valves of the present invention allows manually operated valves to be operated remotely, providing additional operational safety advantages in hydrocarbon wells, as already mentioned. For this purpose, a remote control and monitoring unit is provided, configured not only to operate the system valve(s) to be automated or actuated based on process variables, but also to issue warning signals in the event of system failures.

In another preferred embodiment of the invention, the adjustable device for the automation of manually operated valves of the present invention is configured to be easily installed on conventional actuation and connection means of a manual valve, such as the manual handwheel and the flanges for connecting to existing pipelines.

In a preferred embodiment, the device of the present invention is connected to the inlet and outlet flanges of a manually operated valve by means of a specially designed support, while the valve is actuated by a motor connected to the valve handwheel via its power output shaft for mechanical actuation, said motor being supported by said support.

In another even more preferred embodiment, the device of the present invention comprises a three-dimensionally adjustable support configured to adapt to any valve size and shape of the actuating handwheel.

Furthermore, the device of the present invention has been designed to accept a standard drive motor, for which standardized fastening means are provided, allowing the use of motors from different manufacturers commercially available in different parts of the world.

In a preferred embodiment, the manual valve automation device of the present invention comprises a specially designed position indicator mechanism that turns the rotational movement of the motor output shaft connected to the valve handwheel into a linear approach and retreat movement. Said position indicator mechanism includes a position sensor conveniently located to determine the valve position at all times. The position sensor is configured to emit a signal associated with the change in the motor's direction of rotation, thus making it possible to determine whether the valve is opening or closing at all times.

Should problems arise in the operation of the valve actuator, the external power source, and/or the motor, among other problems, the actuator device can be quickly and easily removed from the valve handwheel, freeing the latter for manual operation.

In this way, it is possible to partially remove the automation device from the valve handwheel, saving operating time in an emergency.

In accordance with the present invention, an adjustable device for the automation of manually operated valves is provided, which offers numerous advantages over the prior art, summarized as follows:
It allows for universal automation of manually operated valves, particularly gate valves;
It allows for remote operation of manual valves;
It does not require personnel to enter the hazardous area to operate the valve;
It improves the operational safety of the site;
It is compatible with any valve design, that is, it is compatible with valves from various manufacturers;
It is compatible with all pressure ranges, sizes, material types, and performance requirements;
It incorporates a control panel to monitor the entire valve operation autonomously and remotely;
It saves operating time thanks to its ability to be partially uninstalled in the event of failures in the automated drive system.

### BRIEF DESCRIPTION OF THE FIGURES

FIG. 1 shows a general perspective view of the adjustable device for automating manual valves of the present invention, installed on a manually operated valve.

FIG. 2 shows a right side view thereof.

FIG. 3A shows a top view thereof.

FIG. 3B shows an enlarged detail of the position indicator mechanism of the device for automating a manual valve according to the present invention in a first operating position.

FIG. 3C shows an enlarged detail of the position indicator mechanism of the device for automating a manual valve according to the present invention in a second operating position.

FIG. 4 shows a front view of the device of the present invention.

FIG. 5 shows an environmental configuration of the present invention.

### DETAILED DESCRIPTION OF THE INVENTION

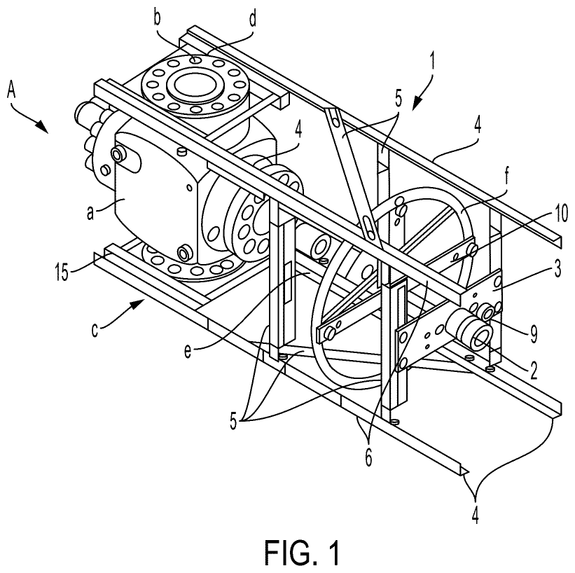

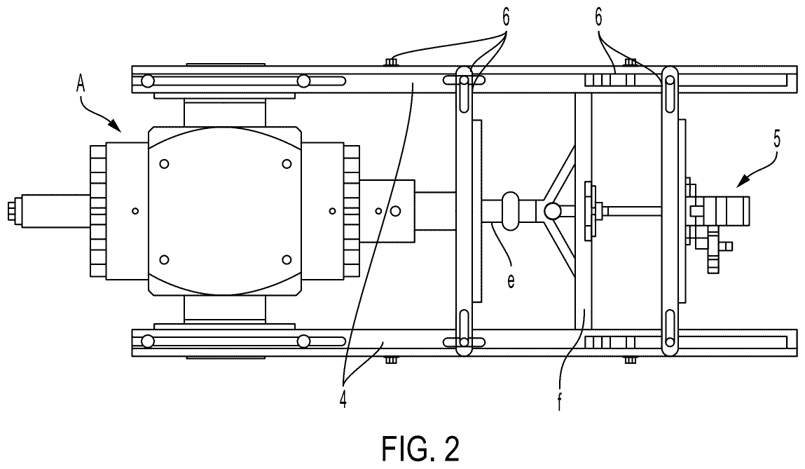

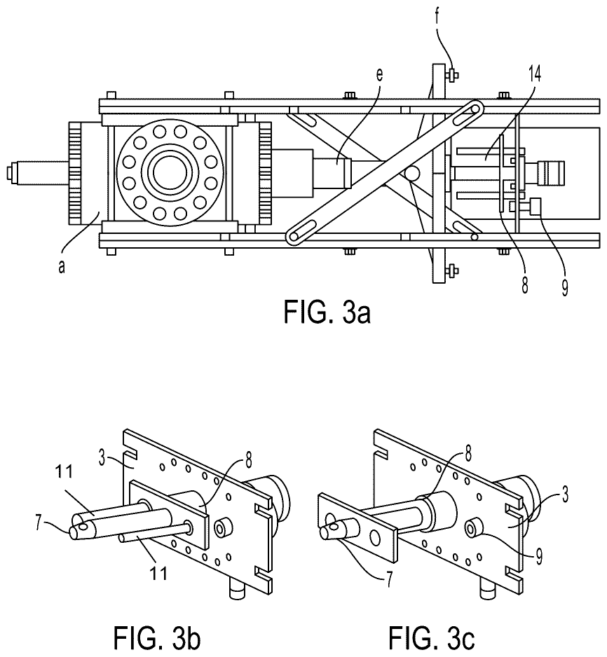

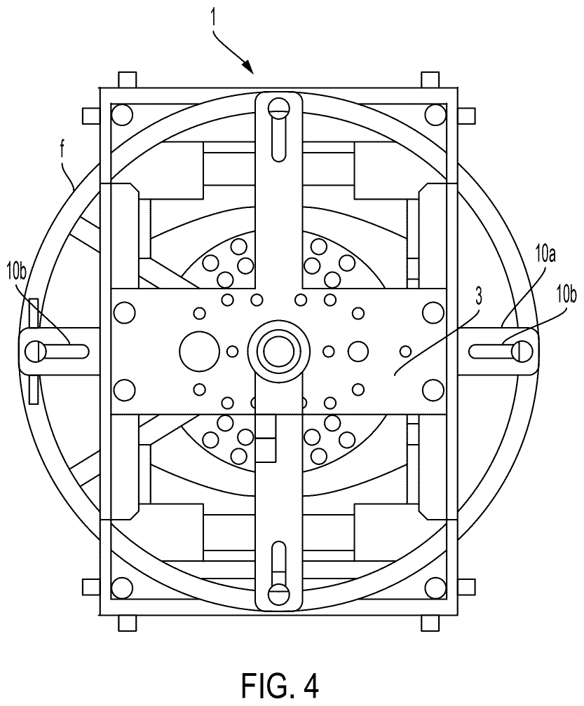

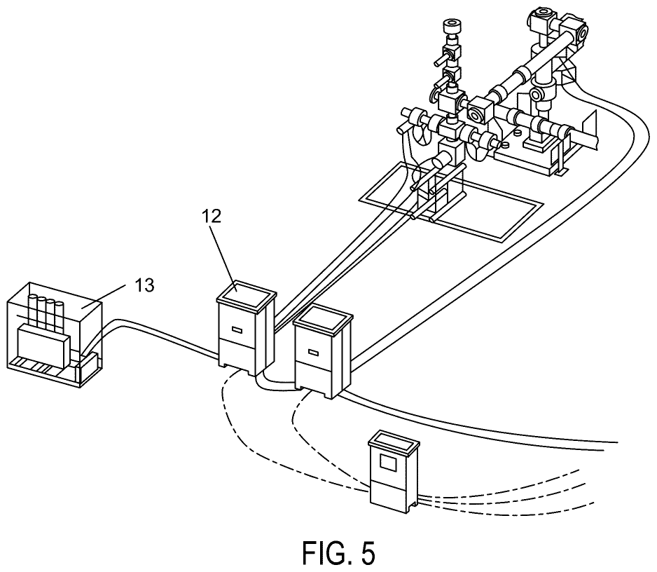

The invention will now be described with reference to an embodiment illustrated in FIGS. 1 to 5. However, it should not be construed as being limited to this example, as it may encompass equivalent elements that would be evident to a person of ordinary skill in the art based on the present description and general knowledge in the technical field of the invention.

The invention relates to an adjustable device for the automation of manually operated valves that is configured to be installed on a valve (A), preferably an existing one, in an oil, gas or water fracturing or production facility, although it can be installed on any valve for industrial use, where said manually operated valve comprises a valve body a) with a fluid inlet b) and a fluid outlet c), where said fluid inlet a) and said fluid outlet b) comprise connection means d) for connecting to respective fluid inlet and outlet conduits (for example, a flange), an actuating stem e) connected by one of its ends to an element for opening and closing the valve, and by its opposite end, to a manually operated handwheel f) of valve A, where the adjustable device for the automation of manually operated valves comprises:
i—an adjustable support 1 configured to be connected to said connection means d) of said manually operated valve A,
ii—a drive motor 2 mounted on said adjustable support 1,
iii—a rotating shaft 7 configured to be operatively connected at one end to said drive motor 2 through the power output shaft thereof and at its opposite end to said valve handwheel f),
iv—an external power source 13 in communication with said drive motor 2, and
v—a remote control and monitoring unit 12 in communication with at least one position sensor 9 configured to determine the position of valve A, and where said remote control and monitoring unit 12 is configured to actuate said valve through said drive motor 2.

In a preferred embodiment of the invention, the adjustable device for automating a manual valve comprises a position indicator mechanism 14 to determine the position of valve A in real time. The position indicator mechanism 14 comprises a linear sliding plate 8 that is operatively connected to and moves on the rotating shaft 7. Said rotating shaft 7 is connected at one end to the valve handwheel f) and at the opposite end to the power output shaft of a drive motor 2, such that the rotational movement of the rotating shaft 7 is translated into a linear movement of the linear sliding plate 8 on said rotating shaft 7. The relative distance traveled by the linear sliding plate 8 during the rotation of the rotating shaft 7 is measured by a position sensor 9, preferably mounted on the support structure 1. In an even more preferred embodiment, the position sensor 9 is mounted on a support plate 3 on which the drive motor 2 is also mounted. More particularly, the sensor 9 is preferably located on the motor support plate 2, although it may be located on a support specially designed for that purpose.

Preferably, said position sensor 9 is selected from an ultrasonic sensor or a VPX series valve position indicator-switch for hazardous area applications, such as a VPX-DF or VPX-DW sensor, which are dual position sensors for fracturing and production valves based on a reed switch system that offers an analog output (4-20 mA between the first position and maximum travel) from 0% to 100% of travel, and with a digital option (open/closed).

The VPX series sensors are commercially available and are equipped with protection against various weather conditions, including rain, wind, snow, ice, and dust whirlwinds. They operate within a wide temperature range of −40 °F to 176 °F (−40 °C to 80 °C), and are flameproof, explosion-proof, and intrinsically safe, making the product suitable for a wide variety of applications in potentially hazardous areas.

In this way, knowing the position of the linear sliding plate 8, it is possible to know the position of the handwheel f) of the valve A, and thereby determine any intermediate position between a closing position and an opening position of the valve A.

In another preferred embodiment, the support (1) of the adjustable device for automating a manual valve (A) is configured to accommodate the valve body (A) along with its actuating handwheel (f). Said support (1) is formed by a plurality of longitudinal support bars (4) and a plurality of transverse support bars (5), which are slidably articulated with one another to define a cage-like structure configured to adjust its dimensions to fit any valve (A) design and size. The transverse support bars (5) include bars arranged perpendicularly to the axial direction of the longitudinal support bars (4), as well as bars that are angled relative to the latter, thereby enabling the cage-like structure to modify its dimensions along all three Cartesian axes.

Preferably, both the longitudinal support bars 4 and the transverse support bars 5 have a plurality of sliding clamps 6 that allow said longitudinal support bars 4 and said transverse support bars 5 to be slidably connected to each other by means of a conventional fixing element and to modify their relative distance.

In another preferred embodiment, the support 1 comprises a motor support plate 3 mounted on a pair of transverse bars 5 that are joined to the longitudinal bars 4 by means of the respective sliding clamps 6 such that the distance from the motor support plate 3 to the handwheel f) of the valve A can also be adjusted by this mechanism, allowing the device to be adapted to any valve size.

At the end opposite the support plate 3 of the motor 2, the longitudinal support bars 4 are fixed to the fluid inlet and outlet connection means d) of the valve A (flanged means) by means of at least one adapter element 15, which is configured to, for example, be inserted into the space defined between the respective flanged connection means of the valve d) and the fluid inlet and outlet conduits.

The rotating shaft 7 is preferably a threaded shaft, such that the linear sliding plate 8 mounted on said shaft can slide linearly in the direction of the axial axis in response to clockwise or counterclockwise rotation thereof, resulting in a linear forward or backward movement of the linear sliding plate 8. This linear movement of the linear sliding plate 8 is assisted and secured by guide elements 11 arranged parallel to the axial axis of the rotating shaft 7.

In a preferred embodiment, the guide elements 11 are configured as a pair of axes parallel to each other and parallel to the axial axis of the rotating shaft 7, such that the linear sliding plate (8) is slidably connected to said pair of parallel axes such that during its linear movement driven by the rotation of the rotating shaft 7, said pair of guide elements 11 prevent the linear sliding plate (8) from deflecting during its movement that could cause jamming and/or damage to the thread of the rotating shaft 7.

Preferably, the threaded rotating shaft 7 is connected to the handwheel f) of the valve A by means of a releasable fixing means 10, for example removably engaged components 10a and 10b, capable of being easily and quickly disconnected from the handwheel in case of contingencies, allowing the valve to be operated manually.

The adjustable automation device of the present invention is in communication with a remote control and monitoring unit 12 configured to receive and process data from the position sensor 9 of valve A, as well as data related to the pressure in the valve's inlet and outlet lines, data related to the pressure in the manifold, flow rate data, temperature data, etc., obtained from other sensors conventionally located in the system.

The drive motor 2 is in communication with an external power source 13, which may be electric, pneumatic, or hydraulic. Preferably, the power unit 13 is a stand-alone power unit (HPU: Hydraulic Power Unit).

In a preferred embodiment, the remote control and monitoring unit 12 is configured not only to actuate the automated manual valves but also the actuated valves of a system in accordance with the requirements of, for example, a hydrocarbon production process or a formation fracturing process (e.g., a “zipper frac” process) as well as to control the external power source. Furthermore, the control and monitoring unit 12 is configured to detect a series of contingencies in the operation of a system, for example, by triggering light or sound alert signals in the event of a failure caused by a malfunction of, for example, an automated or actuated valve, such as when the valve does not reach its final position due to sanding, failure of the drive motor, failure of the sensor or position indicator that does not detect movement, among other failures.

In the case of a fracturing installation, this typically comprises a fracturing tree or “fracturing stack” in fluid communication with zipper fracturing equipment. The fracturing tree may include a plurality of actuated valves and manual valves. In particular, the automation device of the present invention may be installed on at least one of said manually actuated valves present in the fracturing stack.

Typically, the fracture tree valves are in communication with an external hydraulic power unit 13 (HPU) also under the control of the remote control and monitoring unit 12 and where the remote control and monitoring unit 12 is configured for remote actuation of said valves in accordance with the parameters required by the fracturing process.

### REFERENCES

Valve A
a) Valve body
b) Fluid inlet
c) Fluid outlet
d) Connecting means
e) Manual actuating stem
f) Manual actuating handwheel
1 Manual valve automation device support
2 Drive motor
3 Motor support plate
4 Longitudinal support bars
5 Transverse support bars
6 Sliding clamps
7 Threaded rotating shaft
8 Linear sliding plates
9 Position sensor
10 Releasable fixing means
11 Guide elements
12 Remote control and monitoring unit
13 Power unit
14 Position indicator mechanism
15 Adapter element

1. An adjustable device for the automation of manually operated valves (A), comprising a valve body (a) with a fluid inlet (b) and a fluid outlet (c), wherein said fluid inlet and fluid outlet comprise connection means (d); an actuating stem (e) connected at one end to an element for opening and closing the valve, and at its opposite end to a manual actuating handwheel (f) of the valve (A), characterized in that the adjustable device for the automation of manually operated valves comprises:
an adjustable support (1) configured to be connected to said connection means (d) of said manually operated valve (A),
a drive motor (2) mounted on said adjustable support (1),
a rotating shaft (7) configured to be operatively connected at one end to said drive motor (2) through the power output shaft thereof and at its opposite end to said valve handwheel (f),
a position sensor (9) disposed on said adjustable support (1) for detecting the position of the valve (A),
a remote control and monitoring unit (12) in communication with said at least one position sensor (9),
wherein said remote control and monitoring unit (12) is configured to actuate said manual valve (A) by means of said drive motor (2).

2. The adjustable device for the automation of manually operated valves (A) according to claim 1, characterized in that it further comprises a position indicator mechanism (14) for determining the position of the valve (A), comprising a linear sliding plate (8) operatively displaceable along the rotating shaft (7).

3. The adjustable device for the automation of manually operated valves (A) according to claim 1, characterized in that said sensor (9) is mounted on a support plate (3) or on a support specially designed for such purpose.

4. The adjustable device for the automation of manually operated valves (A) according to

1. characterized in that said position sensor (9) is selected from an ultrasonic sensor or a valve position indicator-switch of the VPX series for applications in hazardous areas and with an operating temperature range of −40 °F to 176 °F (−40 °C to 80 °C).

5. The adjustable device for the automation of manually operated valves (A) according to claim 1, characterized in that the adjustable support (1) is configured to house the body of a valve (A) together with its actuating handwheel f).

6. The adjustable device for the automation of manually operated valves (A) according to claim 1, characterized in that said adjustable support (1) comprises a plurality of longitudinal support bars (4) and a plurality of transverse support bars (5) that are slidably connected to each other to define a cage-type structure, said cage-type structure being configured to modify its dimensions along all three Cartesian axes.

7. The adjustable device for the automation of manually operated valves (A) according to claim 6, characterized in that both the longitudinal support bars (4) and the transverse support bars (5) have a plurality of sliding clamps (6) that allow said longitudinal support bars (4) and said transverse support bars (5) to be slidably connected to each other by means of a conventional fixing element.

8. The adjustable device for the automation of manually operated valves (A) according to claim 3, characterized in that said motor (2) is supported on said support plate (3).

9. The adjustable device for the automation of manually operated valves (A) according to claim 8, characterized in that said support plate (3) is mounted on a pair of transverse bars (5) such that the distance from the support plate (3) to the handwheel (f) of the valve (A) is also adjustable.

10. The adjustable device for the automation of manually operated valves (A) according to claim 1, characterized in that the longitudinal support bars (4) are fixed to the fluid inlet and fluid outlet connection means (d) of the valve (A) by means of at least one adapter element (15).

11. The adjustable device for the automation of manually operated valves (A) according to claim 1, characterized in that the rotating shaft (7) is a threaded shaft.

12. The adjustable device for the automation of manually operated valves (A) according to claim 2, characterized in that the sliding plate (8) can slide linearly in the direction of the axial axis of the rotating shaft (7) in response to clockwise or counterclockwise rotation thereof, causing a linear forward or backward movement of the linear sliding plate (8).

13. The adjustable device for the automation of manually operated valves (A) according to claim 12, characterized in that the linear movement of the linear sliding plate (8) is assisted by guide elements (11).

14. The adjustable device for the automation of manually operated valves (A) according to claim 13, characterized in that the guide elements (11) are configured as a pair of axes parallel to each other and parallel to the axial axis of the rotating shaft (7).

15. The adjustable device for the automation of manually operated valves (A) according to claim 1, characterized in that the rotating shaft (7) is connected to the handwheel (f) of the valve (A) by means of a releasable fixing means (10).

16. The adjustable device for the automation of manually operated valves (A) according to claim 1, characterized in that the remote control and monitoring unit (12) is configured to receive and process data received from at least one position sensor (9) of the automated manual valve (A) as well as data related to the pressure in the inlet and outlet lines of the automated and actuated valve, pressure in the manifold, flow rate data, temperature data, among other variables.

17. The adjustable device for the automation of manually operated valves (A) according to claim 1, characterized in that the drive motor (2) communicates with an external power unit (13).

18. The adjustable device for the automation of manually operated valves (A) according to claim 17, wherein the external power unit (13) is an autonomous hydraulic power unit.
